(19) United States
(12) Patent Application Publication
(10) Pub. No.: US 2008/0060323 A1
(43) Pub. Date: Mar. 13, 2008

(54) HARNESS, SUCH AS A HORSERIDING BRIDLE OR SNAFFLE BRIDLE, FOR LIMITING THE PRESSURE EXERTED ON THE NAPE OF THE ANIMAL

(75) Inventor: Fabrice CRESPEL, Souvigny-En-Sologne (FR)

Correspondence Address: YOUNG & THOMPSON, 745 SOUTH 23RD STREET, 2ND FLOOR, ARLINGTON, VA, 22202, US

(73) Assignee: HERMES SELLIER, PARIS (FR)

(21) Appl. No.: 11/851,404

(22) Filed: Sep. 7, 2007

(30) Foreign Application Priority Data
Sep. 7, 2006 (FR) 0607846

(51) Int. Cl. B68B 1/04

(52) U.S. Cl. 54/6.1

(57) ABSTRACT

A harness (1), such as a horseriding bridle or snaffle bridle, intended to be fixed to the head of an animal of the family Equidae, includes a crownpiece (2) for passing over the top of the head, behind the ears of the animal, extended on respective opposite sides by a first cheekpiece (3) and a second cheekpiece (3′) provided with a fixing element (4) for a leverage effect bit (5). The bridle (1) includes an elastic return element (6) adapted to stretch to allow displacement of the fixing element (4) of the leverage effect bit (5) if a traction force is applied to the fixing element (4), in order to absorb the pressure exerted by the crownpiece (2) on the nape of the animal, and to revert to their initial position if no force is applied to the fixing element (4).

The invention concerns a harness, such as a horseriding bridle or snaffle bridle, intended to be fixed to the head of an animal belonging to the family Equidae, such as a horse.

The invention is more particularly concerned with bridles or snaffle bridles for fixing a bit with a leverage effect, such as a curb bit. Bridles of this type are generally used for dressage horses or when a horse is reputed to be difficult to mount.

Bridles or snaffle bridles conventionally include a crownpiece disposed over the top of the head of the horse, two cheekpieces extending either side of the head of the horse, a throatlatch passing under the jawbone and a noseband around the nose. Furthermore, the cheekpieces include means for fixing a curb bit and/or means for fixing a snaffle bit.

A snaffle bit consists of two bit rings, attached to the cheekpieces, disposed on either side of the head of the horse and between which is disposed a mouthpiece inserted in the mouth of the horse at the corner of the lips. Snaffle reins have two ends fastened to the bit rings and it is therefore possible to control and adjust the pace of the horse.

A curb bit consists of a rod called the mouthpiece that crosses the mouth, pressing on the tongue and the lower lip, fastened to two shanks disposed on either side of the mouth, and two rings disposed at the upper end of the shanks for fixing the curb bit to the cheekpieces of the bridle.

Curb reins are fixed to the anterior ends of the shanks and pulling on the reins fixed to the lower ends of the shanks causes tilting of the bit, whose mouthpiece presses on the gums. The sensation of pressure indicates to the dressage horse that it must slow down or turn. Furthermore, the curb bit acts on the head of the horse to lower it. It is therefore possible to orient the neck of the horse.

However, when a force is exerted by the reins on the curb bit, the tilting of the shanks leads to a traction force on the cheekpieces that is transferred to the nape of the horse in the region of the crownpiece.

This pressure on the nape of the horse, which can be relatively high, is a source of inconvenience and trauma for the animal.

The invention aims to solve this problem by proposing a harness, such as a bridle or snaffle bridle, for fixing a bit with a leverage effect enabling reduction of the pressure exerted on the nape of the animal on tilting of the leverage effect bit, in order to enhance the comfort of the harness and to avoid trauma for the animal.

To this end, a first aspect of the invention proposes a harness, such as a horseriding bridle or snaffle bridle, intended to be fixed to the head of an animal of the Equidae family, comprising a crownpiece for passing over the top of the head, behind the ears of the animal, extended on respective opposite sides by a first cheekpiece and a second cheekpiece provided with fixing means for a leverage effect bit.

The bridle comprises elastic return means adapted to stretch to allow displacement of the fixing means of the leverage effect bit if a traction force is applied to said fixing means, in order to absorb the pressure exerted by the crownpiece on the nape of the animal, and to revert to their initial position if no force is applied to said fixing means, the tension of the elastic return means being adapted so that said elastic return means are stretched if the force applied to said fixing means is above a loading threshold and remain in their initial position if said force is below said threshold.

Thus when the elastic return means are taut, the inconveniences caused by pressure on the leverage effect bit are reduced and when the elastic return means are in their initial position the bridle is firmly held onto the head of the animal.

The elastic return means advantageously comprise a first end fastened to the first cheekpiece and a second end fastened to the second cheekpiece. In one embodiment the elastic return means take the form of an elastic strip.

Thus the invention is relatively simple to use because the elastic return means can consist of only one elastic strip for elasticating both the first and second cheekpieces.

The crownpiece advantageously further comprises a sleeve in which the elastic return means are housed. Thus the elastic return means are protected and rubbing on the head of the animal is limited because the elastic return means are not in direct contact with the animal.

The cheekpieces advantageously have an upper portion housed in said sleeve. Consequently, the upper portion of the cheekpieces slides in the sleeve when the elastic return means are stretched or return to their initial position and rubbing between the upper portion of the cheekpieces and the animal is limited.

The sleeve is advantageously equipped with stop means for limiting the movement of the first and second cheekpieces inside the sleeve. Thus a force applied asymmetrically to the leverage effect bit does not cause any imbalance of the bridle.

In one embodiment, the sleeve is formed of two superposed strips fixed to each other by their lateral edges.

The harness advantageously further comprises a browband consisting of a strap having at each of its ends a loop associating it with the cheekpieces in which said cheekpieces slide. Consequently, the movement of the browband is not linked to the movement of the cheekpieces, which also limits rubbing.

Other objects and advantages of the invention will become apparent in the course of the following description, given with reference to the appended drawings, in which:

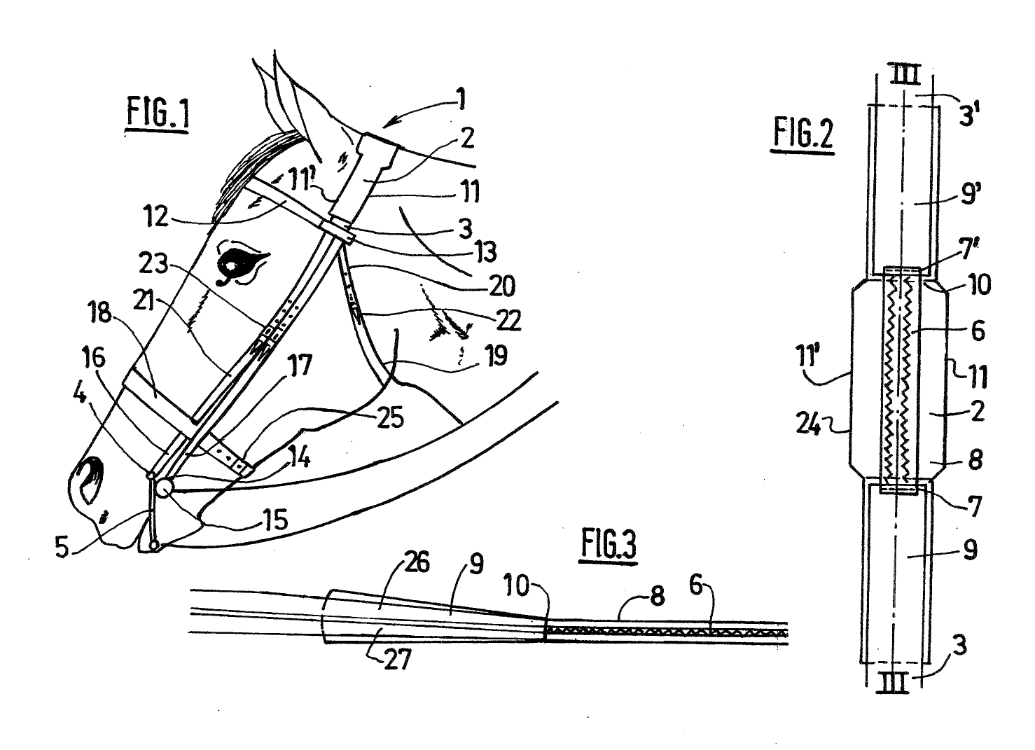

FIG. 1 is a diagrammatic representation of a bridle according to the invention, said bridle being fitted to the head of a horse;

FIG. 2 is a diagrammatic representation of a crownpiece according to the invention seen as if transparent; and

FIG. 3 is a diagrammatic representation of a portion of the crownpiece in longitudinal section taken along the line III-III in FIG. 2.

Although the invention is more particularly intended to be fixed to the head of a horse, it will be noted that it could equally be used for other dressage animals belonging to the Equidae family.

There is described hereinafter a horseriding bridle 1 in its normal position in which it is fixed to the head of a horse. The terms “upper” and “lower” therefore refer to a bridle 1 in the position of use, as represented in FIG. 1.

In the embodiment represented, the leverage effect bit is a curb bit 5.

The horseriding bridle 1 represented in FIG. 1 comprises a crownpiece 2 extended on either side by cheekpieces 3, 3′, a browband 12, a noseband 18 and a throatlatch 19.

When the bridle 1 is fixed to the head of a horse, the headband 2 passes over the nape, behind the ears of the horse, the browband 12 passes across the forehead of the animal, the throatlatch 19 passes under the lower jawbone, and the noseband 18 is placed over the nose, above the nostrils, in order to prevent the horse from opening its mouth and thereby attempting to rid itself of the curb bit 5 or the snaffle bit 15. Thus the bridle 1 is firmly held onto the head of the horse.

The cheekpieces 3, 3′ extend on either side of the head of the animal, connect the crownpiece 2, the browband 12 and the noseband 18 and are also used to attach the curb bit 5 and the snaffle bit 15.

Each cheekpiece 3, 3′ includes two superposed strips 26, 27 connected to each other in the upper portion 9 of the cheekpiece 3, 3′. In the lower portion of the cheekpieces 3, 3′ each strip is divided into two straps 16, 17, 20, 21. Thus the lower portion of the cheekpiece 3, 3′ includes four straps 16, 17, 20, 21 extending its upper portion 9.

The first strap 20 is used to fix the throatlatch 19. The throatlatch 19 is a strap associated with the first strap 20 by means of an adjuster 22 for example. The second strap 21 is used to fix the noseband 18. The noseband 18 is also associated with the second strap 21 by means of an adjuster 23.

Finally, the third strap 16 and fourth strap 17, known as the bridle cheekpiece 16 and the snaffle bridle cheekpiece 17, are respectively provided with fixing means 4 for the curb bit 5 and fixing means 14 for the snaffle bit 15. The third strap 16 and the fourth strap 17 are also equipped with an adjuster 24.

The adjusters 22, 23, 24 are buckles, for example.

In the embodiment represented, the fixing means 4, 14 of the curb bit 5 and snaffle bit 15 consist of a perforation at the end of the bridle cheekpiece 16 or the snaffle bridle cheekpiece 17 and adapted to be disposed around a stud attached to said cheekpiece 16, 17 to form a loop around the ring of the curb bit 5 or the snaffle bit 15.

In an embodiment represented in FIG. 2, the crownpiece 2 consists of a sleeve 8 and elastic return means 6.

The elastic return means 6 are housed inside the sleeve 8 and have a first end 7 fixed to a first cheekpiece 3 and a second end 7′ fixed to a second cheekpiece 3′. The elastic return means 6 take the form, for example, of a strip of elastic fabric that is sewn to the upper portion 9, 9′ of the cheekpieces 3, 3′.

The tension of the elastic return means 6 is chosen so that they stretch if the force applied to the fixing means 4 of the curb bit 5 is above a loading threshold and remain in their initial position if the force is below said threshold. Thus if the curb bit 5 is loaded violently by the rider, the elastic return means 6 stretch to absorb the force exerted on the nape of the horse whereas if the curb bit 5 is loaded to a lesser extent, the force is transmitted to the mouthpiece of the curb bit 5 so as to control the horse.

In one particular embodiment, the elastic strip is sewn between the two superposed strips forming the upper portion 9 of the cheekpiece 3, 3′.

To limit rubbing of the cheekpieces 3, 3′ on the animal, the upper portion 9, 9′ of the cheekpieces 3, 3′ is also partially housed in the sleeve 8. Said upper portion 9, 9′ of the cheekpieces is therefore mobile in translation inside the sleeve 8 if the elastic return means are stretched and then return to their initial position.

In one embodiment, the sleeve 8 is formed by two superposed strips fixed to each other at their lateral edges 11, 11′. The strips can in particular be strips of leather sewn together.

The sleeve 8 has two lateral portions in which are housed the upper portions 9, 9′ of the cheekpieces 3, 3′ and a median portion 24 in contact with the nape of the animal. In order to enhance the distribution of the forces exerted on the nape, the median portion 24 is wider than the lateral portions.

The sleeve 8 is equipped with stop means 10 for defining a stable position of the first cheekpiece 3 and the second cheekpiece 3′ in the sleeve 8. These stop means 10 limit the displacement of the cheekpieces 3, 3′ toward the interior of the sleeve 8. Thus if a higher force is exerted on one side of the curb bit 5, the opposite cheekpiece 3, 3′ does not slide inside the sleeve 8. Consequently, an asymmetric force exerted on the curb bit does not cause any imbalance of the bit.

The stop means 10 are formed by reducing the size of the interior space of the sleeve, for example.

In the embodiment represented in FIG. 3, we note that the thickness of the strips 25, 26 decreases progressively toward the upper end of the cheekpieces 3, 3′ while the passage formed inside the sleeve 8 grows smaller in size toward the interior of the sleeve 8. Thus the areas of the cheekpieces 3, 3′ and the sleeve 8 forming the stops are relatively large.

In the embodiment represented, the browband 12 is a strap including at each of its ends loops 13 associating it with the cheekpieces 3, 3′. Said association loops 13 are arranged so that the cheekpieces 3, 3′ slide in said loops 13 if the elastic return means 6 are stretched or return to their initial position. Thus the browband 12 remains substantially immobile on movement of the elastication means 6, which contributes to good retention of the bridle 1 and limits rubbing of the bridle 1 on the animal.

The noseband 18 also consists of a strap, which runs around the nose of the horse and also includes adjuster means 25 in order to be adapted to the morphology of the animal.

It will be noted that the bridle 1 can be made from any appropriate material such as leather or nylon.

1. Harness (1), such as a horseriding bridle or snaffle bridle, intended to be fixed to the head of an animal of the Equidae type, comprising a crownpiece (2) for passing over the top of the head, behind the ears of the animal, extended on respective opposite sides by a first cheekpiece (3) and a second cheekpiece (3′) provided with fixing means (4) for a leverage effect bit (5), characterized in that said bridle (1) comprises elastic return means (6) adapted to stretch to allow displacement of the fixing means (4) of the leverage effect bit (5) if a traction force is applied to said fixing means (4), in order to absorb the pressure exerted by the crownpiece (2) on the nape of the animal, and to revert to their initial position if no force is applied to said fixing means (4), the tension of the elastic return means (6) being adapted so that said elastic return means (6) are stretched if the force applied to said fixing means (4) is above a loading threshold and remain in their initial position if said force is below said threshold.

2. Harness (1) according to claim 1, characterized in that the crownpiece (2) comprises said elastic return means (6).

3. Harness (1) according to claim 2, characterized in that the elastic return means (6) comprise a first end (7) fastened to the first cheekpiece (3) and a second end (7′) fastened to the second cheekpiece (3′).

4. Harness (1) according to claim 1, characterized in that the elastic return means (6) take the form of an elastic strip.

5. Harness (1) according to claim 2, characterized in that the crownpiece (2) further comprises a sleeve (8) in which the elastic return means (6) are housed.

6. Harness (1) according to claim 5, characterized in that the cheekpieces (3, 3′) have an upper portion (9, 9′) housed in said sleeve (8).

7. Harness (1) according to claim 6, characterized in that the sleeve (8) is equipped with stop means (10) for limiting the movement of the first cheekpiece (3) and the second cheekpiece (3′) toward the interior of the sleeve (8).

8. Harness (1) according to claim 7, characterized in that the stop means (10) are formed by a reduction in the size of the passage formed inside the sleeve (8).

9. Harness (1) according to claim 5, characterized in that the sleeve (8) is formed of two superposed strips fixed to each other by their lateral edges (11, 11′).

10. Harness (1) according to claim 1, characterized in that it further comprises a browband (12) associated with the cheekpieces (3, 3′) and intended to be disposed across the forehead of the animal.

11. Harness (1) according to claim 10, characterized in that the browband (12) is a strap having at each of its ends a loop (13) associating it with the cheekpieces (3, 3′) in which said cheekpieces (3, 3′) slide.

12. Harness (1) according to claim 1, characterized in that the cheekpieces (3, 3′) are further provided with fixing means (14) for a snaffle bit (15).

13. Harness (1) according to claim 12, characterized in that each cheekpiece (3, 3′) comprises a bridle cheekpiece (16) and a snaffle bridle cheekpiece (17) extending the upper portion (9, 9′) of said cheekpiece and respectively equipped with fixing means (4) for a curb bit (5) and fixing means (14) for a snaffle bit (15).

14. Harness (1) according to claim 13, characterized in that the fixing means (4) for a curb bit (5) and/or the fixing means (14) for a snaffle bit (15) consist of a perforation formed at the end of the bridle cheekpiece (16) or the snaffle bridle cheekpiece (17) adapted to be fitted around a stud fastened to said cheekpiece (16, 17).

15. Harness (1) according to claim 1, characterized in that it comprises a noseband (18) associated with the cheekpieces (3, 3′) and intended to be placed around the nose of the animal, above its nostrils.

16. Harness (1) according to claim 1, characterized in that it comprises a throatlatch (19) associated with the cheekpieces (3, 3′) and intended to pass under the lower jawbone of the animal.

17. Harness (1) according to claim 2, characterized in that the elastic return means (6) take the form of an elastic strip.

18. Harness (1) according to claim 3, characterized in that the elastic return means (6) take the form of an elastic strip.

19. Harness (1) according to claim 3, characterized in that the crownpiece (2) further comprises a sleeve (8) in which the elastic return means (6) are housed.

20. Harness (1) according to claim 4, characterized in that the crownpiece (2) further comprises a sleeve (8) in which the elastic return means (6) are housed.
